(19) United States
(12) Patent Application Publication
(10) Pub. No.: US 2024/0140824 A1
(43) Pub. Date: May 2, 2024

(54) INTEGRATED DEVICE AND METHOD FOR ENRICHMENT, PURIFICATION AND SEPARATION OF MICROPLASTICS IN SECONDARY EFFLUENT

(71) Applicant: Xi’AN UNIVERSITY OF ARCHITECTURE AND TECHNOLOGY, Shaanxi (CN)

(72) Inventors: Rui Miao, Shaanxi (CN); Wenjuan Zhang, Shaanxi (CN); Chengshu Yang, Shaanxi (CN); Haoxue Ran, Shaanxi (CN); Lei Wang, Shaanxi (CN)

(73) Assignee: Xi’AN UNIVERSITY OF ARCHITECTURE AND TECHNOLOGY, Shaanxi (CN)

(21) Appl. No.: 18/498,019

(22) Filed: Oct. 30, 2023

(30) Foreign Application Priority Data
Oct. 31, 2022 (CN) 202211349055.4

(51) Int. Cl. C02F 1/00

(52) U.S. Cl. CPC C02F 1/004; C02F 2101/30

(57) ABSTRACT

An integrated device and method for enrichment, purification and separation of microplastics in a secondary effluent are provided. This integrated device comprises a micro-spray system and a filtering system with multi-stage filtering units, and marked screen meshes were installed in each filtering unit. The microplastics in secondary effluent are enriched on the surface of the marked screen meshes through the retaining effect. Then, lower concentration of alkali, acid or oxidant combined with the heat treatment to weaken the interaction forces between the inorganic/organic foulants and the enriched microplastic. On this basis, the micro-spray system was used to rinse the multistage filtration system, which generated shear force to carry away the foulants on the surfaces of the enriched microplastics, thereby achieving the purification and separation of microplastics synchronously. These are performed in the marked screen meshes, in which the microplastic are not subject to any path transfer or loss.

### CROSS-REFERENCE TO RELATED APPLICATION

This application claims the priority benefit of China application serial no. 202211349055.4, filed on Oct. 31, 2022. The entirety of the above-mentioned patent application is hereby incorporated by reference herein and made a part of this specification.

### BACKGROUND

### Technical Field

The disclosure belongs to the technical field of wastewater treatment and foulant evaluation, and mainly relates to an integrated device and method for enrichment, purification and separation of microplastics in the secondary effluent.

### Description of Related Art

Microplastics are a new type of foulant that has raised considerable attention and concern due to the fouling problem they have caused. Wastewater treatment plants are the direct “receptors” of terrestrial microplastics. In the meantime, because the secondary effluent from wastewater treatment plants is normally discharged directly into the surface water, which is exactly the main source that exhausts microplastics in the entire aquatic ecosystem, thus the control of total discharge of microplastics therefrom is the key to control of total amount of microplastics entering the ecosystem. Therefore, evaluating the situation of microplastics fouling in the secondary effluent of wastewater treatment plants is of great significance to the understanding and control of microplastic fouling in the water environment. But this is necessary first to effectively extract and separate microplastics from the secondary effluent. Currently, the extraction and separation of microplastics in water bodies is typically divided into three steps, i.e., enrichment, purification and separation. However, there is no unified standard method for each step, and the three steps are almost performed independently of each other.

Compared with purification and separation, the enrichment step is relatively simple. Normally, porous media such as trawl nets, plankton nets, screen meshes, etc. are adopted to separate the microplastics from water bodies through physical interception. However, in addition to the difference in pore sizes of the porous media used by different researchers, the problem of narrowed pore size during the separation process is not taken into consideration, which eventually affects the accurate analysis of the quantity and shape of the collected microplastics, and to a certain extent limits the comparison between relevant properties of the microplastics in water bodies.

After enrichment, in order to avoid the interference of organic foulants on the performance analysis and identification of microplastics, the enriched microplastics are normally transferred from porous media to beakers for purification treatment, which is also the most critical and most concerned operation in conventional methods. The currently adopted purification methods involve acid degradation, alkaline degradation, and oxidation degradation. Mainly, by introducing strong acids, strong bases or oxidants, the molecular structure of the organic foulant is destroyed to be degraded and removed. However, in conventional methods, it normally takes several days to several tens of days for degradation to be completed, and the concentration of acid, base and oxidant (H₂O₂) adopted is as high as tens of moles, which will not only destroy the molecular structure of the organic foulant, but will also be very likely to damage the structural properties of the microplastics themselves, causing great damage and loss to the microplastic samples, and ultimately affecting the accurate analysis and evaluation of microplastics quantitatively and qualitatively.

After purification, the microplastic sample needs to be separated from the degradation solution again, and then transferred to a density separation medium for density separation. Density separation liquid is mainly a saturated salt solution of sodium chloride, sodium iodide or zinc chloride. By using the density difference between microplastics and other foulants, it is possible for the foulant particles to sink to the bottom, and the microplastics with lower density are suspended on the surface of the solution, that is, in the supernatant. Finally, the supernatant is filtered through the screen mesh with different pore sizes to separate microplastics therefrom, so as to realize the separation of light microplastics and denser foulants. However, the separation effect that can be achieved by each saturated salt solution is limited. For example, saturated sodium chloride solution can only effectively separate low-density microplastics, and cannot separate high-density microplastics, such as polyvinyl chloride and polyethylene terephthalate, which leads to a large loss of microplastics in actual water samples, and ultimately affects the accurate analysis of microplastic foulants in fouled water bodies.

To sum up, the current enrichment, purification and separation of microplastics in water bodies is a “complicated” and diversified process. Each processing unit is independent of each other and microplastic samples need to be separated and transferred many times during the whole process. On one hand, the operation process inevitably causes a large loss of microplastics in water samples; and on the other hand, the conventional purification and density separation process introduces a large amount of high-concentration chemicals, resulting in the loss and destruction of microplastic samples, which ultimately leads to a large discrepancy between the analysis result and the actual situation. Therefore, it is particularly important to further optimize and develop a microplastic extraction method that is more efficient and accurate to meet the need of research in current situation of microplastic fouling in the secondary effluent.

### SUMMARY

Based on the significant technical problem in the current extraction process of microplastics in water bodies, the purpose of the present disclosure is to provide an integrated device and method for enrichment, purification and separation of microplastics in the secondary effluent, which is able to enrich the microplastics from the secondary effluent onto the surfaces of marked screen meshes. On the basis of not introducing a high-concentration chemical reagent, purification and separation treatment of the microplastics is carried out in-situ, thereby providing an efficient and accurate microplastics extraction method for accurate analysis of the situation of microplastics fouling in a fouled water body.

The present disclosure is achieved through the following technical schemes.

The present disclosure provides an integrated device and method for the enrichment, purification and separation of microplastics in secondary effluent, and the method includes the following steps: mounting marked screen meshes labeled with respective mesh numbers respectively in filtering units of all stages integrated in a filtering system in an order that the mesh numbers of the marked screen meshes are decreased successively with an increase of the stage of the filtering unit; adding a secondary effluent from wastewater treatment plants into the filtering system, wherein microplastics in the secondary effluent are retained on a surface of the marked screen meshes mounted in the filtering unit of each stage, and spraying ultra-pure water on the surface of the marked screen meshes by a micro-spray system to obtain enriched microplastics; mounting a fixed screen mesh in the filtering unit of each stage to perform in-situ purification and separation of the enriched microplastics; and leaving the filtering system standing in a constant temperature environment to remove residual moisture from surfaces of the microplastics, followed by taking the marked screen mesh out of the filtering unit of each stage to analyze and identify relevant properties of the microplastics.

Preferably, the in-situ purification and separation steps comprise the following steps:
a. rinsing an interior of the filtering system with an NaOH solution by the micro-spray system, then adding the NaOH solution into the filtering system until the fixed screen mesh in a last-stage filtering unit was immersed completely, followed by leaving the filtering system standing in the constant temperature environment;
b. opening a water outlet to drain the NaOH solution, followed by rinsing the interior of the filtering system with ultra-pure water by the micro-spray system and then rinsing the interior of the filtering system with an HCl solution at room temperature, closing the water outlet, adding the HCl solution into the filtering system until the fixed screen mesh in the last-stage filtering unit was immersed completely, and then leaving the filtering system standing in the constant temperature environment;
c. opening the water outlet to drain the HCl solution, followed by rinsing the interior of the filtering system with ultra-pure water at room temperature by the micro-spray system and then rinsing the interior of the filtering system with a NaClO solution at room temperature, closing the water outlet, adding the NaClO solution into the filtering system until the fixed screen mesh in the last-stage filtering unit was immersed completely, and letting the filtering system proceed with a dark reaction at room temperature; and
d. opening the water outlet to drain the NaClO solution, followed by rinsing the interior of the filtering system with ultra-pure water by the micro-spray system to complete the in-situ purification and separation.

Preferably, the interior of the filtering system is rinsed with the NaOH solution having a pH of 9 to 11 at a temperature of 30° C. to 40° C. by the micro-spray system for 5 minutes to 10 minutes, and the filtering system is left standing in the constant temperature environment at 40° C. to 50° C. for 0.5 hour to 2 hours.

Preferably, the interior of the filtering system is rinsed with ultra-pure water at 40° C. to 50° C. by the micro-spray system, then the interior of the filtering system is rinsed with the HCl solution having a pH of 3 to 5 at room temperature for 5 minutes to 10 minutes, and the filtering system is left standing in the constant temperature environment at 40° C. to 60° C. for 3 hours to 5 hours.

Preferably, the interior of the filtering system is rinsed with the NaClO solution having a concentration of 8 mg/L to 16 mg/L at room temperature for 5 minutes to 10 minutes; and the filtering system is subjected to the dark reaction at room temperature for 1 hour to 3 hours.

Preferably, the interior of the filtering system is rinsed with ultra-pure water at 30° C. to 50° C. by the micro-spray system for 10 minutes to 20 minutes.

The present disclosure further provides an integrated device for enrichment, purification and separation of microplastics in a secondary effluent adopted by the method of any one of claims 1-6, comprising a micro-spray system and a filtering system; wherein the filtering system comprises multi-stage filtering units, of which a first-stage filtering unit is connected to a base, and a last-stage filtering unit is mounted at an entrance of the secondary effluent; and the filtering unit of each stage is composed of a cup body as well as a fixed screen mesh and a marked screen mesh mounted in the cup body, wherein the cup body at a bottom is connected to the base, which is provided with a water outlet.

Preferably, the cup bodies of the filtering units of adjacent stages are connected through a lathedog, and the cup body at the bottom is connected to the base also through a lathedog (first-stage filtering unit).

Preferably, the marked screen mesh is a stainless steel screen mesh with 16 meshes to 2,000 meshes, the fixed screen mesh is mounted at an upper end of the marked screen mesh, and a distance between the fixed screen mesh and the marked screen mesh ranges from 2 cm to 4 cm.

Preferably, both the mesh numbers of the marked screen mesh and the fixed screen mesh in the filtering units of all stages decrease successively with an increase of the stage number of the filtering unit, and a mesh number m of the marked screen mesh and a mesh number M of the fixed screen mesh satisfy the following relationship:

M=m×(2−3.75)

The present disclosure has the following advantageous effects by adopting the above technical schemes.

(1) It can be seen from the technical schemes of the present disclosure that after the microplastics in the secondary effluent are enriched onto the surfaces of the marked screen meshes, the purification and separation treatment can be performed in-situ on the surfaces of the marked screen meshes and the whole process is carried out in a relatively sealed filtering system of the integrated device, in which the microplastic samples are not subject to any path transfer, thereby effectively preventing the loss of microplastic samples occurred in the conventional multi-step method.

(2) The purification and separation process of microplastics involved in the present disclosure uses low-concentration acids, alkalis and oxidants combined with heat treatment to purposefully reduce the affinity potential energy between the organic/inorganic foulants and microplastics, and further use the shear force generated when the ultra-pure water passes through the screen mesh to remove the foulants on the surfaces of microplastics, thereby achieving the purification and separation of microplastics. The above process effectively avoids the damage and loss of surface properties of microplastic samples caused by high-concentration chemicals.

(3) The present disclosure involves multiple stages of filtering units, in which the corresponding aperture of the screen mesh ranges from 16 meshes to 2,000 meshes, and the corresponding filtering accuracy ranges from 5 microns to 1,000 microns, so all the microplastic particles with a size greater than or equal to 5 microns in the secondary effluent can be effectively retained, and there is no need to separate the microplastics again after the purification and separation process, thereby avoiding the problem of microplastics loss occurred in the conventional methods. The method of the present disclosure is simple and easy to implement, and has low cost and wide applicability. The present disclosure is not only suitable for the secondary effluent, but also can be used for the extraction and separation of microplastics in the fouled water bodies, such as surface water, lake water and groundwater.

### BRIEF DESCRIPTION OF THE DRAWINGS

The accompanying drawings illustrated herein are used to provide a further understanding of the present disclosure and constitute a part of the present disclosure, and are not intended to limit the scope of the present disclosure.

FIG. 1 is an integrated device for the enrichment, purification and separation of microplastics in a secondary effluent.

FIG. 2A to FIG. 2C show typical fibrous microplastics in a secondary effluent of an A²O-sedimentation tank of a wastewater treatment plant, in which FIG. 2A is a diagram showing linear fibers, FIG. 2B is a diagram showing dendritic fibers, and FIG. 2C is a diagram showing curled fibers.

FIG. 3A to FIG. 3C show typical microplastics in a secondary effluent of an oxidation ditch-sedimentation tank of a wastewater treatment plant, in which FIG. 3A is a diagram showing linear fibers, FIG. 3B is a diagram showing fragments, and FIG. 3C is a diagram showing particles.

FIG. 4A to FIG. 4C show microplastics of typical type in a secondary effluent of a multi-section AO-sedimentation tank in a wastewater treatment plant, in which FIG. 4A is a diagram showing linear fibers, FIG. 4B is a diagram showing microspheres, and FIG. 4C is a diagram showing thin films.

FIG. 5A to FIG. 5C show microplastics of typical type in a secondary effluent of an A²O-MBR process in a wastewater treatment plant, in which FIG. 5A is a diagram showing linear fibers, FIG. 5B is a diagram showing linear fibers, and FIG. 5C is a diagram showing thin films.

### DESCRIPTION OF THE EMBODIMENTS

The present disclosure will be described in detail below in conjunction with the accompanying drawings and specific embodiments, where the schematic embodiments and descriptions of the present disclosure are used to illustrate the present disclosure, but are not intended to limit the present disclosure.

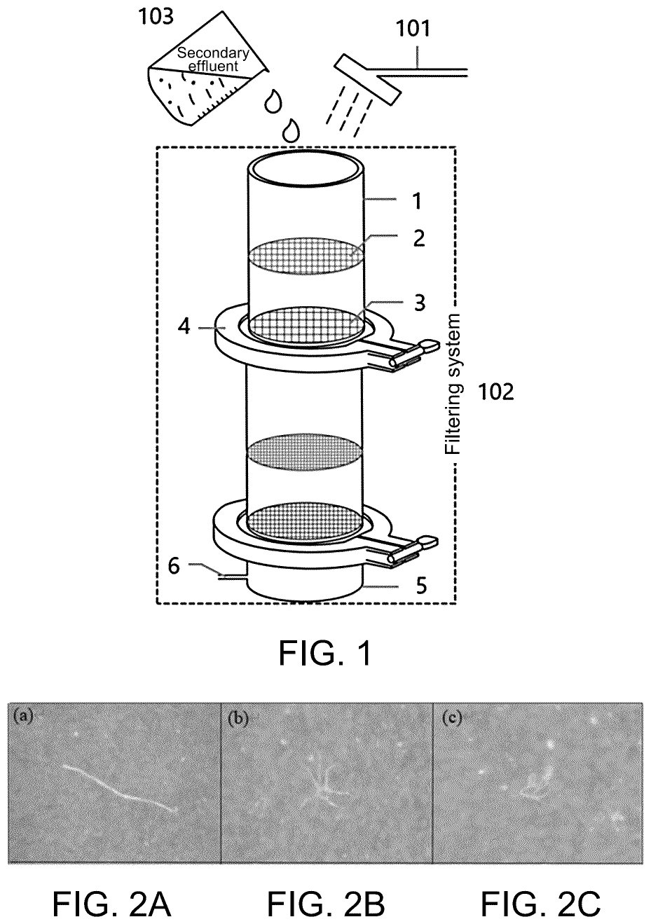

As shown in FIG. 1, an integrated device and method for the enrichment, purification and separation of microplastics in a secondary effluent provided by the embodiments of the present disclosure include a micro-spray system 101 and a filtering system 102. The filtering system 102 includes two-stage, three-stage or four-stage filtering units. Each filtering unit is composed of a cup body 1 as well as a fixed screen mesh 2 and a marked screen mesh 3 mounted in the cup body 1. The cup bodies of any two adjacent filtering units are connected by a lathedog 4. The cup body 1 at the bottom is connected to the base 5 through a lathedog and constitutes the first-stage filtering unit. The last-stage filtering unit is mounted at the entrance of the secondary effluent, and the base 5 is provided with a water outlet 6.

In the device of the present disclosure, the marked screen mesh mounted in the filtering unit of each stage is set to be a stainless-steel screen mesh with 16 meshes to 2,000 meshes according to the size and morphological characteristics of microplastics. The mesh numbers of the marked screen mesh and the fixed screen mesh in the filtering unit of each stage decrease successively as the stage of the filtering unit increases. According to the length-to-diameter ratio and the probability range of passage through the fixed screen mesh of fibrous microplastics, it is obtained that the mesh number of the fixed screen mesh is 2 times to 3.75 times that of the marked screen mesh.

Moreover, according to the water head loss when the aqueous solution passes through the screen mesh, the fixed screen mesh 2 is set at a position that is 2 cm to 4 cm from the upper end of the marked screen mesh 3. According to the sampling volume of actual secondary effluent, the cup body is set to be organic glass with an inner diameter of 5 cm to 10 cm.

Based on the above device, an integrated device and method for the enrichment, purification and separation of microplastics in a secondary effluent provided by the present disclosure are realized through the following steps.

(1) Preparation of the marked screen meshes: In order to ensure the accurate quantification of microplastic samples under the microscope in the later stage, the marked screen meshes with different mesh numbers are labelled respectively with a marker pen to obtain the various marked screen meshes.

(2) Simultaneously, the marked screen meshes are examined under a stereo microscope to ensure that the marked screen meshes themselves do not carry any microplastics. Afterwards, these marked screen meshes are successively mounted in all the filtering units of the filtering system such that the mesh numbers of the marked screen meshes are decreased gradually with an increase of the stage of the filtering unit to be ready for use.

(3) Enrichment of microplastics: The secondary effluent 103 from the wastewater treatment plant is uniformly mixed, of which 500 mL to 2,000 mL of water samples are taken and poured into the integrated device. The microplastics in the secondary effluent will be retained on the surface of the marked screen mesh in the filtering unit of each stage. Because the secondary effluent normally contains a large amount of microbial metabolite and a small amount of small-scale sludge, 1,000 mL of ultra-pure water at 30° C. to 40° C. is sprayed on the surface of the marked screen meshes by a micro-spray system, and the walls of the cup body is washed using a washing bottle along the walls. On one hand, the loose foulants adhered to the surfaces of the microplastics are removed, and on the other hand, the microplastics are converged on the surface of the marked screen meshes through the fluid shear force.

(4) In-situ purification and separation of microplastics: The fixed screen mesh is mounted in the filtering unit of each stage, and then the enriched microplastics are subjected to in-situ purification and separation.

i. First, an interior of the filtering system is rinsed with an NaOH solution having a pH of 9 to 11 at 30° C. to 40° C. for 5 minutes to 10 minutes by the micro-spray system to adjust the filtering system to an alkaline environment, and part organic foulants are removed from the surfaces of the microplastics. The water outlet is then closed, and the NaOH solution of the same temperature and pH is added into the filtering system until the fixed screen mesh in the last-stage filtering unit is immersed completely. Afterwards, based on the type of foulants in the secondary effluent, the deprotonation efficiency and net charge of organic foulants in the alkaline environment, etc., the filtering system is left standing in a constant temperature environment at 40° C. to 50° C. for 0.5 hour to 2 hours to weaken the binding force between the organic foulants and microplastics.

ii. The water outlet is then opened to drain the NaOH solution, followed by rinsing the interior of the filtering system with ultra-pure water at 40° C. to 50° C. by the micro-spray system, which means that the shear force generated during the passage of the ultra-pure water through the screen mesh is utilized to remove the organic foulants from the surfaces of the microplastics. Afterwards, the interior of the filtering system is rinsed with an HCl solution having a pH of 3 to 5 at room temperature for 5 minutes to 10 minutes to adjust the filtering system to an acidic environment, and the shear force is also utilized to remove the loose foulants from the surfaces of the microplastics. The water outlet is closed, and the HCl solution of the same pH is added into the filtering system until the fixed screen mesh in the last-stage filtering unit is completely immersed. Thereafter, according to the main types of inorganic foulants in the secondary effluent, especially the properties of the scalant, the integrated device is left standing in the constant temperature environment at 40° C. to 60° C. for 3 hours to 5 hours to destroy the morphology of the inorganic foulants layer and the binding force between the inorganic foulants and the microplastics.

iii. The water outlet is then opened to drain the HCl solution, followed by rinsing the interior of the filtering system with ultra-pure water at room temperature by the micro-spray system, which means that the shear force generated during the passage of the ultra-pure water through the screen meshes is utilized to remove the inorganic foulants from the surfaces of the microplastics. Thereafter, the interior of the filtering system is rinsed with 8 mg/L to 16 mg/L of NaClO solution at room temperature for 5 minutes to 10 minutes. The water outlet is then closed, and the NaClO solution of the same concentration is added into the integrated device until the fixed screen mesh in the last-stage filtering unit is completely immersed. The filtering system is subjected to a dark reaction at room temperature for 1 hour to 3 hours, in which the surface properties of organic foulants are mainly modified through different degrees of oxidation to increase the electrostatic repulsion force between the organic foulants and the microplastics and weaken the hydrogen bonds and the hydrophobic forces, thereby destroying the attachment of the organic matter that has a strong binding force with the microplastics on the surfaces of the microplastics.

iv. The water outlet is opened to drain the NaClO solution. The interior of the filtering system is then rinsed thoroughly with ultra-pure water at 30° C. to 50° C. by the micro-spray system for 10 minutes to 20 minutes during which the shear force generated by the fluid are utilized to remove residual foulants from the surfaces of the microplastics, thereby completing the purification treatment.

(5) Post-treatment: After the purification treatment is completed, the correlation between the surface properties of the microplastics and temperature as well as the removal efficiency of residual moisture are comprehensively considered, and the filtering system is left standing in the constant temperature environment at 50° C. for 1 hour to 2 hours to remove residual moisture from the surfaces of the microplastics. Thereafter, the marked screen meshes is taken out for the analysis and identification of the microplastics' relevant properties.

The present disclosure will be described in further detail below through specific examples.

### Example 1

An integrated device and method for enrichment, purification and separation of microplastics in a secondary effluent of the present disclosure are adopted to analyze the situation of microplastics fouling in the secondary effluent of an A²O-sedimentation tank process of a wastewater treatment plant, which is implemented through the following steps.

In the integrated device for enrichment, purification and separation of microplastics in the secondary effluent of the wastewater treatment plant, four-stage filtering units are provided at the upper end of the filtering system, in which the first-stage filtering unit is connected to the base, and the fourth-stage filtering unit is mounted at the entrance of the upper secondary effluent. For the filtering unit of each stage, the fixed screen mesh is set at 2 cm from the upper end of the marked screen meshes, and the cup body is made of organic glass with an inner diameter of 5 cm. The mesh numbers of the marked screen meshes and the fixed screen mesh in the first-stage filtering unit are 2,000 meshes and 5,000 meshes respectively; and the mesh ratio of the fixed screen mesh to the marked screen meshes is 2.5. The mesh numbers of the marked screen meshes and the fixed screen mesh in the second-stage filtering unit are 500 meshes and 1,000 meshes respectively; and the mesh ratio of the fixed screen mesh to the marked screen meshes is 2.0. The mesh numbers of the marked screen meshes and the fixed screen mesh in the third-stage filtering unit are 100 meshes and 300 meshes respectively; and the mesh ratio of the fixed screen mesh to the marked screen meshes is 3.0. The mesh numbers of the marked screen meshes and the fixed screen mesh in the fourth-stage filtering unit are 16 meshes and 60 meshes respectively; and the mesh ratio of the fixed screen mesh to the marked screen meshes is 3.75.

Based on the above device, the enrichment, purification and separation of the microplastics in the secondary effluent of the wastewater treatment plant is implemented through the following steps.

(1) Preparation of the marked screen mesh: The screen meshes are labelled with a marker pen and to check that the screen mesh itself does not carry any microplastics. Thereafter, the labelled screen mesh, i.e., the marked screen mesh, is mounted in the filtering unit of each stage of the filtering system to be ready for use.

(2) Enrichment of microplastics: The obtained secondary effluent from the wastewater treatment plant is uniformly mixed, and 1,500 mL of water samples are taken and poured into the filtering system. The microplastics in the secondary effluent will be retained on the surface of the marked screen meshes in the filtering unit of each stage. Thereafter, 1,000 mL of ultra-pure water at 40° C. is sprayed on the surface of the marked screen meshes by the micro-spray system, and the walls of the cup body are washed along the walls using the washing bottle.

(3) In-situ purification and separation of microplastics: The fixed screen mesh is mounted in the filtering unit of each stage, and then the microplastics are subjected to in-situ purification and separation.

i. The interior of the filtering system is rinsed with the NaOH solution having a pH of 11 at 40° C. by the micro-spray system for 5 minutes. The water outlet is closed, and the NaOH solution of the same temperature and pH is added into the filtering system until the fixed screen mesh in the last-stage filtering unit is completely immersed. Thereafter, the filtering system is left standing in the constant temperature environment at 50° C. for 0.5 hour.

ii. The water outlet is opened to drain the NaOH solution, and the interior of the filtering system is rinsed with ultra-pure water at 50° C. by the micro-spray system. Afterwards, the interior of the filtering system is rinsed with the HCl solution having a pH of 3 at room temperature for 5 minutes. The water outlet is then closed, and the HCl solution of the same pH is added into the filtering system until the fixed screen mesh in the last-stage filtering unit is completely immersed. Thereafter, the filtering system is left standing in the constant temperature environment at 40° C. for 5 hours.

iii. The water outlet is opened to drain the HCl solution, and the interior of the filtering system is rinsed with ultra-pure water at room temperature by the micro-spray system. Afterwards, the interior of the filtering system is rinsed with 16 mg/L NaClO solution at room temperature for 5 minutes. The water outlet is then closed, and the NaClO solution of the same concentration is added into the filtering system until the fixed screen mesh in the last-stage filtering unit is completely immersed. Thereafter, the filtering system is subjected to the dark reaction at room temperature for 1 hour.

iv. The water outlet is opened to drain the NaClO solution, and the interior of the filtering system is thoroughly rinsed with ultra-pure water at 50° C. by the micro-spray system for 10 minutes. After performing the above, the purification process is completed.

(4) Post-treatment: After the purification treatment is completed, the filtering system is left standing in the constant temperature environment at 50° C. for 2 hours to remove residual moisture from the surfaces of the microplastics. Thereafter, the marked screen meshes are taken out to analyze and identify relevant properties of the microplastics.

The results of four sampling analyses show that the abundance of the microplastics in the secondary effluent are 288±44, 324±23, 258±36 and 322±26 pcs/L respectively. Further qualitative analysis of microplastic samples show that the separation accuracy of the microplastics reaches 96%. FIG. 2A to FIG. 2C show typical fibrous microplastics in the secondary effluent of the A²O-sedimentation tank of the wastewater treatment plant.

### Example 2

An integrated device and method for enrichment, purification and separation of microplastics in a secondary effluent of the present disclosure are adopted to analyze the situation of microplastics fouling in the secondary effluent of an oxidation ditch-sedimentation tank process of a wastewater treatment plant, which is implemented through the following steps.

In the integrated device for enrichment, purification and separation of microplastics in the secondary effluent of the wastewater treatment plant, three-stage filtering units are provided at the upper end of the filtering system, in which the first-stage filtering unit is connected to the base, and the third-stage filtering unit is mounted at the entrance of the upper secondary effluent. For the filtering unit of each stage, it comprises marked screen meshes, a fixed screen mesh and a cup body, in which the fixed screen mesh is set at 3 cm from the upper end of the marked screen meshes, and the cup body is made of organic glass with an inner diameter of 7 cm. The mesh numbers of the marked screen meshes and the fixed screen mesh in the first-stage filtering unit are 2,000 meshes and 5,000 meshes respectively; and the mesh ratio of the fixed screen mesh to the marked screen meshes is 2.5. The mesh numbers of the marked screen meshes and the fixed screen mesh in the second-stage filtering unit are 150 meshes and 500 meshes respectively; and the mesh ratio of the fixed screen mesh to the marked screen meshes is 3.3. The mesh numbers of the marked screen meshes and the fixed screen mesh in the third-stage filtering unit are 32 meshes and 100 meshes respectively; and the mesh ratio of the fixed screen mesh to the marked screen meshes is 3.13.

Based on the above device, the enrichment, purification and separation of the microplastics in the secondary effluent of the wastewater treatment plant is implemented through the following steps.

(1) Preparation of the marked screen mesh: The screen meshes are labelled with a marker pen and to check that the screen mesh itself does not carry any microplastics. Thereafter, the labelled screen mesh, i.e., the marked screen meshes, is mounted in the filtering unit of each stage of the filtering system to be ready for use.

(2) Enrichment of microplastics: The obtained secondary effluent from the wastewater treatment plant is uniformly mixed, and 1,000 mL of water samples are taken and poured into the filtering system. The microplastics in the secondary effluent will be retained on the surface of the marked screen meshes in the filtering unit of each stage. Thereafter, 1,000 mL of ultra-pure water at 35° C. is sprayed on the surface of the marked screen meshes by the micro-spray system, and the walls of the cup body are washed along the walls using the washing bottle.

(3) In-situ purification and separation of microplastics: The fixed screen mesh is mounted in the filtering unit of each stage, and then the microplastics are subjected to in-situ purification and separation.

i. The interior of the filtering system is rinsed with the NaOH solution having a pH of 10 at 40° C. by the micro-spray system for 7 minutes. The water outlet is closed, and the NaOH solution of the same temperature and pH is added into the filtering system until the fixed screen mesh in the last-stage filtering unit is completely immersed. Thereafter, the filtering system is left standing in the constant temperature environment at 40° C. for 1 hour.

ii. The water outlet is opened to drain the NaOH solution, and the interior of the filtering system is rinsed with ultra-pure water at 40° C. by the micro-spray system. Afterwards, the interior of the filtering system is rinsed with the HCl solution having a pH of 4 at room temperature for 8 minutes. The water outlet is then closed, and the HCl solution of the same pH is added into the filtering system until the fixed screen mesh in the last-stage filtering unit is completely immersed. Thereafter, the filtering system is left standing in the constant temperature environment at 50° C. for 3 hours.

iii. The water outlet is opened to drain the HCl solution, and the interior of the filtering system is rinsed with ultra-pure water at room temperature by the micro-spray system. Afterwards, the interior of the filtering system is rinsed with 12 mg/L NaClO solution at room temperature for 7 minutes. The water outlet is then closed, and the NaClO solution of the same concentration is added into the filtering system until the fixed screen mesh in the last-stage filtering unit is completely immersed. Thereafter, the filtering system is subjected to the dark reaction at room temperature for 2 hours.

iv. The water outlet is opened to drain the NaClO solution, and the interior of the filtering system is thoroughly rinsed with ultra-pure water at 40° C. by the micro-spray system for 15 minutes. After performing the above, the purification process is completed.

(4) Post-treatment: After the purification treatment is completed, the filtering system is left standing in the constant temperature environment at 50° C. for 1.5 hours to remove residual moisture from the surfaces of the microplastics. Thereafter, the marked screen meshes are taken out to analyze and identify relevant properties of the microplastics.

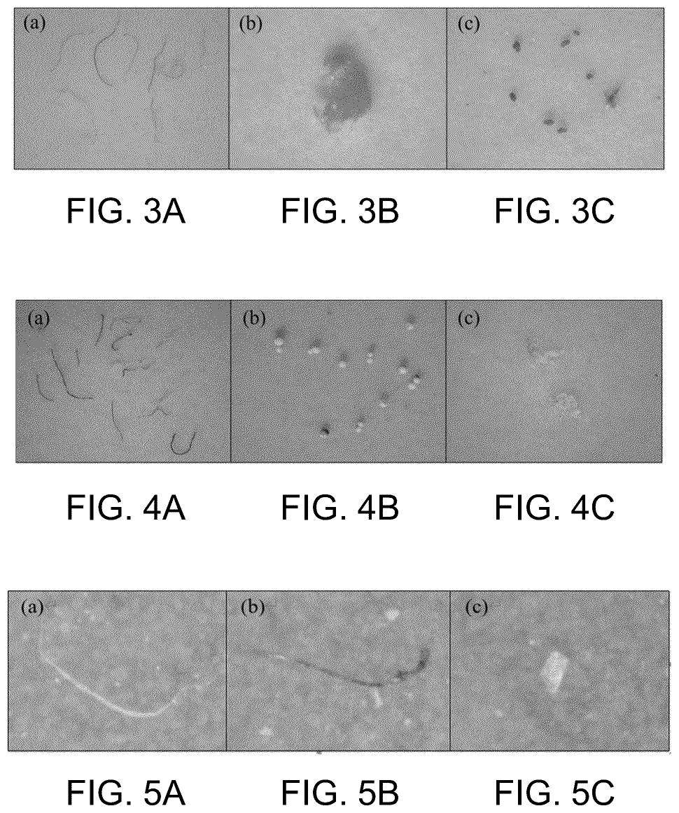

The results of four sampling analyses show that the abundance of the microplastics in the secondary effluent are 328±20, 254±25, 380±30 and 286±25 pcs/L respectively. Further qualitative analysis of microplastic samples show that the separation accuracy of the microplastics reaches 90%. FIG. 3A to FIG. 3C show typical microplastics in the secondary effluent of the oxidation ditch-sedimentation tank of the wastewater treatment plant.

### Example 3

An integrated device and method for enrichment, purification and separation of microplastics in a secondary effluent of the present disclosure are adopted to analyze the situation of microplastics fouling in the secondary effluent of a multi-section AO-sedimentation tank process of a wastewater treatment plant, which is implemented through the following steps.

In the integrated device for enrichment, purification and separation of microplastics in the secondary effluent of the wastewater treatment plant, two-stage filtering units are provided at the upper end of the filtering system, in which the first-stage filtering unit is connected to the base, and the second-stage filtering unit is mounted at the entrance of the upper secondary effluent. For the filtering unit of each stage, it comprises marked screen meshes, a fixed screen mesh and a cup body, in which the fixed screen mesh is set at 4 cm from the upper end of the marked screen meshes, and the cup body is made of organic glass with an inner diameter of 10 cm. The mesh numbers of the marked screen meshes and the fixed screen mesh in the first-stage filtering unit are 2,000 meshes and 4,000 meshes respectively; and the mesh ratio of the fixed screen mesh to the marked screen meshes is 2. The mesh numbers of the marked screen meshes and the fixed screen mesh in the second-stage filtering unit are 50 meshes and 180 meshes respectively; and the mesh ratio of the fixed screen mesh to the marked screen meshes is 3.6.

Based on the above device, the enrichment, purification and separation of the microplastics in the secondary effluent of the wastewater treatment plant is implemented through the following steps.

(1) Preparation of the marked screen mesh: The screen meshes are labelled with a marker pen and to check that the screen mesh itself does not carry any microplastics. Thereafter, the labelled screen mesh, i.e., the marked screen meshes, is mounted in the filtering unit of each stage of the filtering system to be ready for use.

(2) Enrichment of microplastics: The obtained secondary effluent from the wastewater treatment plant is uniformly mixed, and 500 mL of water samples are taken and poured into the filtering system. The microplastics in the secondary effluent will be retained on the surface of the marked screen meshes in the filtering unit of each stage. Thereafter, 1,000 mL of ultra-pure water at 30° C. is sprayed on the surface of the marked screen meshes by the micro-spray system, and the walls of the cup body are washed along the walls using the washing bottle.

(3) In-situ purification and separation of microplastics: The fixed screen mesh is mounted in the filtering unit of each stage, and then the microplastics are subjected to in-situ purification and separation.

i. The interior of the filtering system is rinsed with the NaOH solution having a pH of 9 at 30° C. by the micro-spray system for 10 minutes. The water outlet is closed, and the NaOH solution of the same temperature and pH is added into the filtering system until the fixed screen mesh in the last-stage filtering unit is completely immersed. Thereafter, the filtering system is left standing in the constant temperature environment at 50° C. for 2 hours.

ii. The water outlet is opened to drain the NaOH solution, and the interior of the filtering system is rinsed with ultra-pure water at 50° C. by the micro-spray system. Afterwards, the interior of the filtering system is rinsed with the HCl solution having a pH of 5 at room temperature for 10 minutes. The water outlet is then closed, and the HCl solution of the same pH is added into the filtering system until the fixed screen mesh in the last-stage filtering unit is completely immersed. Thereafter, the filtering system is left standing in the constant temperature environment at 60° C. for 5 hours.

iii. The water outlet is opened to drain the HCl solution, and the interior of the filtering system is rinsed with ultra-pure water at room temperature by the micro-spray system. Afterwards, the interior of the filtering system is rinsed with 10 mg/L NaClO solution at room temperature for 10 minutes. The water outlet is then closed, and the NaClO solution of the same concentration is added into the filtering system until the fixed screen mesh in the last-stage filtering unit is completely immersed. Thereafter, the filtering system is subjected to the dark reaction at room temperature for 3 hours.

iv. The water outlet is opened to drain the NaClO solution, and the interior of the filtering system is thoroughly rinsed with ultra-pure water at 50° C. by the micro-spray system for 20 minutes. After performing the above, the purification process is completed.

(4) Post-treatment: After the purification treatment is completed, the filtering system is left standing in the constant temperature environment at 50° C. for 1 hour to remove residual moisture from the surfaces of the microplastics. Thereafter, the marked screen meshes are taken out to analyze and identify relevant properties of the microplastics.

The results of four sampling analyses show that the abundance of the microplastics in the secondary effluent are 262±28, 226±23, 376±35 and 288±20 pcs/L respectively. Further qualitative analysis of microplastic samples show that the separation accuracy of the microplastics reaches 92%. FIG. 4A to FIG. 4C show the microplastics of the typical form in the secondary effluent of the multi-section AO-sedimentation tank of the wastewater treatment plant.

### Example 4

An integrated device and method for enrichment, purification and separation of microplastics in the secondary effluent of the present disclosure are adopted to analyze the situation of microplastics fouling in the secondary effluent of an A²O-MBR process of a wastewater treatment plant, which is implemented through the following steps.

In the integrated device for enrichment, purification and separation of microplastics in the secondary effluent of the wastewater treatment plant, two-stage filtering units are provided at the upper end of the filtering system, in which the first-stage filtering unit is connected to the base, and the second-stage filtering unit is mounted at the entrance of the upper secondary effluent. For the filtering unit of each stage, it comprises marked screen meshes, a fixed screen mesh and a cup body, in which the fixed screen mesh is set at 4 cm from the upper end of the marked screen meshes, and the cup body is made of organic glass with an inner diameter of 10 cm. The mesh numbers of the marked screen meshes and the fixed screen mesh in the first-stage filtering unit are 2,000 meshes and 4,000 meshes respectively; and the mesh ratio of the fixed screen mesh to the marked screen meshes is 2.0. The mesh numbers of the marked screen meshes and the fixed screen mesh in the second-stage filtering unit are 120 meshes and 400 meshes respectively; and the mesh ratio of the fixed screen mesh to the marked screen meshes is 3.3.

Based on the above device, the enrichment, purification and separation of the microplastics in the secondary effluent of the wastewater treatment plant is implemented through the following steps.

(1) Preparation of the marked screen meshes: The screen meshes are labelled with a marker pen and to check that the screen mesh itself does not carry any microplastics. Thereafter, the labelled screen mesh, i.e., the marked screen meshes, is mounted in the filtering unit of each stage of the filtering system to be ready for use.

(2) Enrichment of microplastics: The obtained secondary effluent from the wastewater treatment plant is uniformly mixed, and 2,000 mL of water samples are taken and poured into the filtering system. The microplastics in the secondary effluent will be retained on the surface of the marked screen meshes in the filtering unit of each stage. Thereafter, 1,000 mL of ultra-pure water at 35° C. is sprayed on the surface of the marked screen meshes by the micro-spray system, and the walls of the cup body are washed along the walls using the washing bottle.

(3) In-situ purification and separation of microplastics: The fixed screen mesh is mounted in the filtering unit of each stage, and then the microplastics are subjected to in-situ purification and separation.

i. The interior of the filtering system is rinsed with the NaOH solution having a pH of 10 at 35° C. by the micro-spray system for 7 minutes. The water outlet is closed, and the NaOH solution of the same temperature and pH is added into the filtering system until the fixed screen mesh in the last-stage filtering unit is completely immersed. Thereafter, the filtering system is left standing in the constant temperature environment at 45° C. for 0.5 hour.

ii. The water outlet is opened to drain the NaOH solution, and the interior of the filtering system is rinsed with ultra-pure water at 45° C. by the micro-spray system. Afterwards, the interior of the filtering system is rinsed with the HCl solution having a pH of 4 at room temperature for 7 minutes. The water outlet is then closed, and the HCl solution of the same pH is added into the filtering system until the fixed screen mesh in the last-stage filtering unit is completely immersed. Thereafter, the filtering system is left standing in the constant temperature environment at 50° C. for 4 hours.

iii. The water outlet is opened to drain the HCl solution, and the interior of the filtering system is rinsed with ultra-pure water at room temperature by the micro-spray system. Afterwards, the interior of the filtering system is rinsed with 8 mg/L NaClO solution at room temperature for 5 minutes. The water outlet is then closed, and the NaClO solution of the same concentration is added into the filtering system until the fixed screen mesh in the last-stage filtering unit is completely immersed. Thereafter, the filtering system is subjected to the dark reaction at room temperature for 1 hour.

iv. The water outlet is opened to drain the NaClO solution, and the interior of the filtering system is thoroughly rinsed with ultra-pure water at 30° C. by the micro-spray system for 10 minutes. After performing the above, the purification process is completed.

(4) Post-treatment: After the purification treatment is completed, the filtering system is left standing in the constant temperature environment at 50° C. for 1 hour to remove residual moisture from the surfaces of the microplastics. Thereafter, the marked screen meshes are taken out to analyze and identify relevant properties of the microplastics.

The results of four sampling analyses show that the abundance of the microplastics in the secondary effluent of the A²O-MBR process of the wastewater treatment plant are 78±16, 65±19, 81±19 and 72±15 respectively. Further qualitative analysis of microplastic samples show that the separation accuracy of the microplastics reaches 98%. FIG. 5A to FIG. 5C show the microplastics of typical form in the secondary effluent of the A²O-MBR process of the wastewater treatment plant.

It can be seen from the above examples that, by using the method of the present disclosure for the integrated enrichment, purification and separation of microplastics in the secondary effluent of wastewater treatment plants, the separation accuracy of the microplastics is not less than 90%, and may be even as high as 98%. Therefore, the method of the present disclosure provides an efficient and accurate microplastic extraction method for accurate analysis of situation of microplastic fouling in fouled secondary effluent without destroying the physical and chemical properties of the microplastics.

The present disclosure is not limited to the above-mentioned embodiments. On the basis of the technical solutions disclosed in the present disclosure, those skilled in the art can make some replacements and modification for some of the technical features according to the disclosed technical content without creative work. These replacements and modification are within the protection scope of the present disclosure.

What is claimed is:

1. A method for enrichment, purification and separation of microplastics in a secondary effluent, comprising:
mounting marked screen meshes labeled with respective mesh numbers respectively in filtering units of all stages integrated in a filtering system in an order that the mesh numbers of the marked screen meshes are decreased successively with an increase of the stage of the filtering unit;
adding a secondary effluent from a wastewater treatment plant into the filtering system, wherein microplastics in the secondary effluent are retained on a surface of the marked screen meshes mounted in the filtering unit of each stage, and then spraying ultra-pure water on the surface of the marked screen mesh by a micro-spray system to obtain enriched microplastics;
mounting a fixed screen mesh in the filtering unit of each stage to perform in-situ purification and separation of the enriched microplastics; and
leaving the filtering system standing in a constant temperature environment to remove residual moisture from surfaces of the microplastics, followed by taking the marked screen meshes out of the filtering unit of each stage to analyze and identify relevant properties of the microplastics.

2. The method of claim 1, wherein the in-situ purification and separation comprise the following steps:
a. rinsing an interior of the filtering system with an NaOH solution by the micro-spray system, then adding the NaOH solution into the filtering system until the fixed screen mesh in a last-stage filtering unit is immersed completely, followed by leaving the filtering system standing in the constant temperature environment;
b. opening a water outlet to drain the NaOH solution, followed by rinsing the interior of the filtering system with ultra-pure water by the micro-spray system and then rinsing the interior of the filtering system with an HCl solution at room temperature, closing the water outlet, adding the HCl solution into the filtering system until the fixed screen mesh in the last-stage filtering unit is immersed completely, and then leaving the filtering system standing in the constant temperature environment;
c. opening the water outlet to drain the HCl solution, followed by rinsing the interior of the filtering system with ultra-pure water at room temperature by the micro-spray system and then rinsing the interior of the filtering system with a NaClO solution at room temperature, closing the water outlet, adding the NaClO solution into the filtering system until the fixed screen mesh in the last-stage filtering unit is immersed completely, and letting the filtering system proceed with a dark reaction at room temperature; and
d. opening the water outlet to drain the NaClO solution, followed by rinsing the interior of the filtering system with ultra-pure water by the micro-spray system to complete the in-situ purification and separation.

3. The method of claim 2, wherein the interior of the filtering system is rinsed with the NaOH solution having a pH of 9 to 11 at a temperature of 30° C. to 40° C. by the micro-spray system for 5 minutes to 10 minutes, and the filtering system is left standing in the constant temperature environment at 40° C. to 50° C. for 0.5 hour to 2 hours.

4. The method of claim 2, wherein the interior of the filtering system is rinsed with ultra-pure water at 40° C. to 50° C. by the micro-spray system, then the interior of the filtering system is rinsed with the HCl solution having a pH of 3 to 5 at room temperature for 5 minutes to 10 minutes, and the filtering system is left standing in the constant temperature environment at 40° C. to 60° C. for 3 hours to 5 hours.

5. The method of claim 2, wherein the interior of the filtering system is rinsed with the NaClO solution having a concentration of 8 mg/L to 16 mg/L at room temperature for 5 minutes to 10 minutes; and the filtering system is subjected to the dark reaction at room temperature for 1 hour to 3 hours.

6. The method of claim 2, wherein the interior of the filtering system is rinsed with ultra-pure water at 30° C. to 50° C. by the micro-spray system for 10 minutes to 20 minutes.

7. An integrated device for enrichment, purification and separation of microplastics in a secondary effluent adopted by the method of claim 1, comprising a micro-spray system and a filtering system;
wherein the filtering system comprises multi-stage filtering units, of which a first-stage filtering unit is connected to a base, and a last-stage filtering unit is mounted at an entrance of the secondary effluent; and the filtering unit of each stage is composed of a cup body as well as a fixed screen mesh and a marked screen meshes mounted in the cup body, wherein the cup body at a bottom is connected to the base, which is provided with a water outlet.

8. The integrated device of claim 7, wherein the cup body of the filtering units of adjacent stages are connected through a lathedog, and the cup body at the bottom is also connected to the base through a lathedog.

9. The integrated device of claim 7, wherein the marked screen meshes are stainless steel screen meshes with 16 meshes to 2,000 meshes, the fixed screen mesh is mounted at an upper end of the marked screen meshes, and a distance between the fixed screen mesh and the marked screen meshes ranges from 2 cm to 4 cm.

10. The integrated device of claim 9, wherein both the mesh numbers of the marked screen meshes and the fixed screen mesh in the filtering units of all stages decrease successively with an increase of the stage number of the filtering unit, and a mesh number m of the marked screen meshes and a mesh number M of the fixed screen mesh satisfy the following relationship:
M=m×(2−3.75).
